(19) United States
(12) Patent Application Publication
(10) Pub. No.: US 2008/0080972 A1
(43) Pub. Date: Apr. 3, 2008

(54) Stationary-rotating assemblies having surface features for enhanced containment of fluid flow, and related processes

(75) Inventor: Ronald Scott Bunker, Niskayuna, NY (US)

Correspondence Address: GENERAL ELECTRIC COMPANY;GLOBAL RESEARCH, PATENT DOCKET RM. BLDG. K1-4A59, NISKAYUNA, NY, 12309, US

(73) Assignee: General Electric Company

(21) Appl. No.: 11/540,741

(22) Filed: Sep. 29, 2006

(51) Int. Cl. F03B 11/00

(52) U.S. Cl. 415/174.5

(57) ABSTRACT

A turbomachine is described, which includes a rotating member having an interface region with a stationary member. The interface region includes a pattern of concavities. A method for restricting the flow of a fluid through a gap between a stationary member and a rotating member is also described. The method includes the step of forming a pattern of concavities on at least one surface of the stationary member or the rotating member. The concavities have a size and shape sufficient to impede fluid flow.

### BACKGROUND OF THE INVENTION

A primary scientific field to which the present invention relates is the design of advanced turbomachines. More specifically, embodiments of the invention are directed to methods and articles for impeding the flow of fluids (e.g., hot gas) through various sections of turbomachines.

Turbomachines are well-known in the art. Examples include gas turbine engines, gas- or liquid-compression units, steam turbines, and the like. Some specific examples of the gas turbine engines include turbojets, turboprops, land-based power generating turbines, and marine propulsion turbine engines. Typical designs for a gas turbine engine include a compressor for compressing air that is mixed with fuel. The fuel-air mixture is ignited in an attached combustor, to generate combustion gases. The hot, pressurized gases, which in modern engines can be in the range of about 1100 to 2000° C., are allowed to expand through a turbine nozzle, which directs the flow to turn an attached, high-pressure turbine. The turbine is usually coupled with a rotor shaft, to drive the compressor. The core gases then exit the high pressure turbine, providing energy downstream. The energy is in the form of additional rotational energy extracted by attached, lower pressure turbine stages, and/or in the form of thrust through an exhaust nozzle.

In operation, thermal energy produced within the combustor is converted into mechanical energy within the turbine, by impinging the hot combustion gases onto one or more bladed rotor assemblies. In most cases, the rotor assembly is actually a component of a “stator-rotor assembly”. The rows of rotor blades on the rotor assembly and the rows of stator vanes on the stator assembly typically extend alternately across an axially oriented flowpath for “working” the combustion gases. (Radially-oriented compressors and turbines are known in the art as well). The jets of hot combustion gas leaving the vanes of the stator element act upon the turbine blades, and cause the turbine wheel to rotate in a speed range of about 3000-15,000 rpm, depending on the type of engine.

The stator-rotor assembly represents an example of a situation where the flow of a fluid—here, hot gas—needs to be restricted. In this case, the opening at an interface between the stator element and the blades or buckets can allow hot core gas to exit the hot gas path and potentially enter the wheel-space of the turbine engine, which is undesirable. Typically, the situation is addressed in part by the incorporation of angel wing seals and discouragers which extend from sections of the adjacent stator/rotor surfaces, thereby constricting the gas flow path. A gap remains at the interface, since it is necessary that there be some clearance at the junction of stationary and rotating components. However, the gap still provides a path which can allow hot core gas to exit the hot gas path into the wheel-space area of the turbine engine. Other design features can ameliorate the problem of hot gas leakage, e.g., the use of purge air diverted from the compressor. However, the use of purge air can sometimes lower engine efficiency.

The need to restrict the flow of fluid in a turbomachine—be it gas or liquid flow—is very important in a variety of locations within the machine. As an example, it is often critical to minimize the leakage of hot gas between a rotor blade tip and the adjacent shroud. Various seals are often used to accomplish this objective. In fact, a turbomachine often must include a large number of different types of seals, some of which are in the form of labyrinth seals, described below. Other examples include high-pressure packing seals between compressor and turbine sections, inducer flow seals, stage-to-stage turbine spacer wheel seals, and shaft leakage seals. Moreover, water turbine systems or steam turbine systems very often require similar types of seals to restrict the flow of water or steam from one pathway to another region.

It is certainly true, then, that flow restriction can be accomplished in part by the use of seals, or by the incorporation of physical structures and appendages which narrow the gap between rotating and stationary components in turbomachines. However, new techniques for reducing the leakage of fluids between stationary and rotating components in a turbomachine would be of considerable interest. The techniques must still adhere to the primary design requirements for the machines, e.g., a gas turbine engine. In general, overall engine efficiency and integrity must be maintained. Moreover, any change made to the turbomachine or to specific components therein must not disturb or adversely affect the overall flow fields established within the machine. The contemplated improvements should also not involve manufacturing steps or changes in those steps which are time-consuming and uneconomical. Furthermore, the improvements should be adaptable to varying designs in engine construction, e.g., those which use gas or liquid as the operating medium.

### BRIEF DESCRIPTION OF THE INVENTION

One embodiment of the invention is directed to a turbomachine, comprising a rotating member having an interface region with a stationary member. The interface region comprises a pattern of concavities.

Another embodiment is directed to a method for restricting the flow of a fluid through a gap between a stationary member and a rotating member in a turbomachine. The method comprises forming a pattern of concavities on at least one surface of the stationary member or the rotating member. The concavities have a size and shape sufficient to impede fluid flow.

These concepts, as well as other features and advantages of the present invention, will become apparent in light of the detailed description of the embodiments set forth below, and depicted in the accompanying drawings.

### BRIEF DESCRIPTION OF THE DRAWINGS

FIG. 1 is a schematic, elevational view of a representative turbine blade for a gas turbine engine.

FIG. 2 is an angular, top planar view of the tip section of a turbine blade

FIG. 3 is a sectional view of an upper portion of the turbine blade of FIG. 1.

FIG. 4 is a partial, side-elevational view of an article surface which includes a concavity.

FIG. 5 is another partial, side-elevational view of an article surface which includes a concavity.

FIG. 6 is another partial, side-elevational view of an article surface which includes a concavity.

FIG. 7 is a sectional view of portion of a turbine rotor blade, depicting a blade tip section and an adjacent shroud

FIG. 8 is sectional view of a portion of a rotor blade and an adjacent shroud casing.

FIG. 9 is a sectional view of a portion of a rotor blade and an adjacent shroud casing.

FIG. 10 is a top planar view of the tip section of the rotor blade of FIG. 9.

FIG. 11 is a cross-sectional depiction of a labyrinth seal between a shroud and the tip section of a turbine blade.

### DETAILED DESCRIPTION OF THE INVENTION

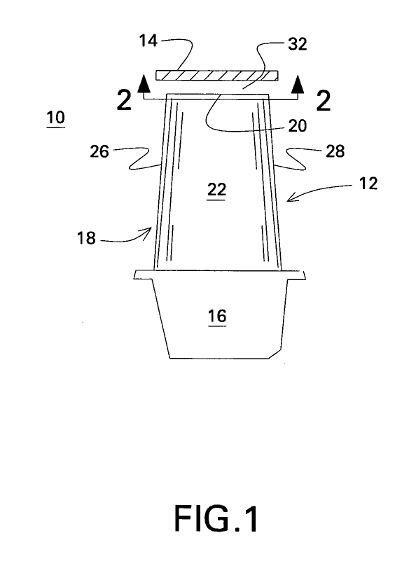

FIG. 1 is a schematic, elevational view of a representative turbine blade for a gas turbine engine. A turbine assembly 10 comprises a rotor blade portion 12. An outer shroud 14 is concentrically disposed about rotor blade portion 12. Rotor blade portion 12 comprises an inner root portion 16, an airfoil 18 and an outer tip portion 20. Airfoil 18 extends outwardly into the working medium flow path of the turbine, where working medium gases exert motive forces on the surfaces thereof. Outer tip portion 20 sometimes includes an attached outer tip shroud (not shown in this figure). Many of these features are also described in U.S. Pat. No. 6,350,102, issued to J. Bailey and R. Bunker, which is incorporated herein by reference.

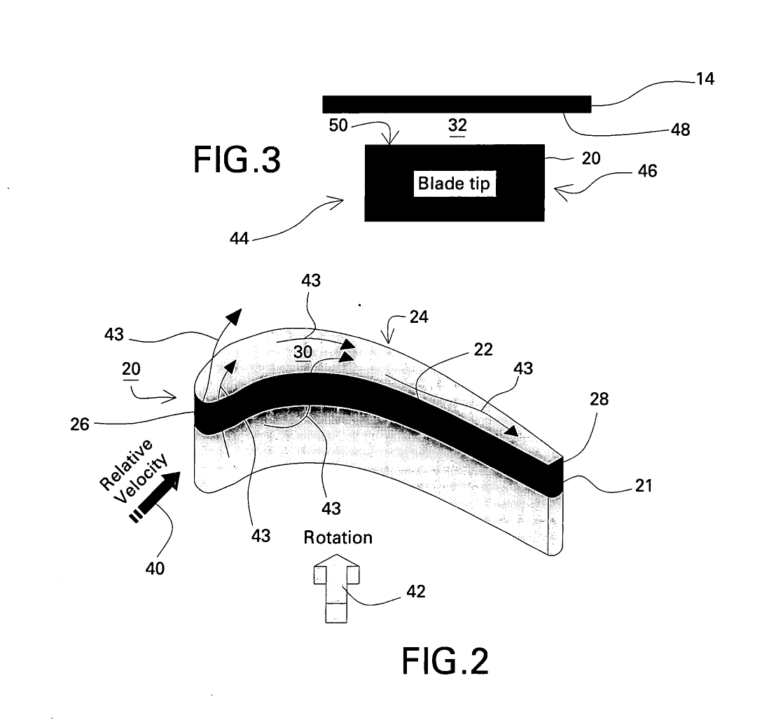

FIG. 2 is an angular, top planar view of the tip section 20 of FIG. 1, taken generally along section 2-2 of FIG. 1. (Upper portion 21 of the tip section is highlighted with a different color-shading). Tip section 20 is defined by pressure sidewall 22, suction sidewall 24, leading edge 26, trailing edge 28, and tip surface 30. The direction of rotation of blade portion 12 (FIG. 1) is represented generally as element 42 in FIG. 2. The typical working fluid direction approaching this section of the turbine blade is indicated with arrow 40. (As described below, this invention can relate to different types of “fluids”, although hot gas is often exemplified). The radial flow of leakage air 43 from the hot gas path is shown flowing over tip surface 30 (i.e., over the top of the blade), and along the chord of the tip section.

With reference to FIG. 1, outer shroud 14 is spaced apart from tip section 20, so as to define a clearance gap 32 therebetween. As generally discussed in the above background section, the performance and efficiency of the turbine is critically affected by clearance gap 32. The greater the amount of leakage-flow through clearance gap 32, the greater the inefficiency of the turbine, as the leakage flow is not exerting motive forces on the blade surfaces and, accordingly, is not providing work.

FIG. 3 is a sectional view of an upper portion of FIG. 1, i.e., illustrating outer shroud 14 and tip section 20. Typically, shroud 14 is structurally supported by a casing (not shown), and more specifically, by way of various casing hangers. The figure also generally indicates pressure side 44 and suction side 46 of the shroud-tip assembly. Lower surface 48 of shroud 14 generally faces tip surface 50 of tip section 20.

In FIG. 3, clearance gap area 32, situated between shroud surface 48 and tip surface 50, represents an interface region. The term “interface region” is used herein to describe a general area of restricted dimension between two surfaces, i.e., the surface of a rotating member with a stationary member. The precise boundary for the interface region will vary in part with the particular turbomachine assembly being considered. For the assembly of FIG. 3, the interface region will extend at least as long as the longest dimension of shroud surface 48. (As described below for other embodiments, an interface region can sometimes extend beyond the exact area in which opposite surfaces face each other).

As those skilled in turbine engine design understand, clearance gap 32 is designed to be as small as possible, while avoiding contact between the facing surfaces. While the relatively small gap functions to restrict the flow of leakage air, it is often highly desirable to further restrict gas flow through the gap. Thus, according to one embodiment of this invention, at least one of the facing surfaces 48 and 50 is provided with a pattern of concavities, which impede gas flow. (The concavities are discussed below).

Although the inventor does not wish to be bound to any particular theory for this phenomenon, it appears that each concavity generates a local, flow vortex as the fluid stream moves thereover. As the vortices are expelled into the fluid stream, they restrict gas flow. In this manner, leakage of gas through the clearance gap (interface region) is restricted. (This general concept is described in an Application for R. Bunker, Ser. No. ______ (Docket 155542-1 for “Stator-Rotor Assemblies Having Surface Features for Enhanced Containment of Gas Flow, and Related Processes”), filed simultaneously with the present Application, and incorporated herein by reference. Application ______ (Docket 155542-1) primarily relates to interface regions within stator-rotor assemblies).

As used herein, the term “concavity” is meant to embrace a very wide variety of depressions, indentations, dimples, pits, or any other type of discrete sinkhole. In some preferred embodiments, each concavity is in the shape of a hemisphere or a partial hemisphere. However, the hemispherical shape need not be geometrically exact, i.e., some variation in its curvature is possible.

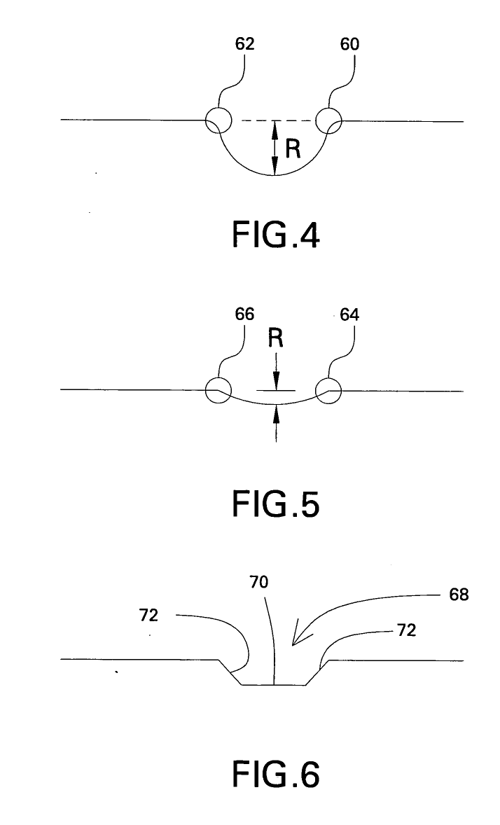

FIGS. 4 and 5 are non-limiting, cross-sectional illustrations of various hemispherical shapes possible for the concavities. In FIG. 4, a full hemisphere is shown, i.e., with a depth equivalent to the full radius R. FIG. 5 depicts a much shallower concavity. Moreover the surface edge of the concavity can vary as well. In FIG. 4, surface edges 60 and 62 are depicted as somewhat rounded, while in FIG. 5, surface edges 64 and 66 are depicted as relatively sharp. (Furthermore, different portions of the surface edges for a given concavity can also vary in shape, e.g., depending on how they are positioned relative to a particular gas flow stream).

As is evident from exemplary FIGS. 4 and 5, the depth of the concavities can vary considerably. Factors which are relevant to selection of optimum depth include the type and speed of gas flow over the concavities (in one or more streams); the degree to which gas flow should be restricted; the shape and size of the stationary and/or rotating surfaces on which the concavities are located; the manner in which the concavities are to be formed; and the size of the local interface region. In general, the depth of the concavities for a typical assembly in a commercial turbomachine will vary from about 0.5 mm to about 6 mm. In the case of hemispherical or partially-hemispherical concavities, the depth will typically range from about 0.5 mm to about 6 mm, and more often, from about 0.5 mm to about 2.5 mm. Those skilled in the art will be able to select the most appropriate concavity depth for a given situation, based on the factors mentioned above, as well as fluid flow studies, discharge coefficient tests, computational fluid dynamics predictions, and the like.

As mentioned above, concavities with other shapes are also possible. As one non-limiting illustration, the concavity 68 (FIG. 6) could have a relatively flat bottom surface 70, along with slanted sidewalls 72, so that the opening of the concavity has a greater area than its bottom 70. The degree of inclination of the sidewalls can vary significantly, depending on many of the other factors set forth herein.

The concavities can be arranged in a variety of many different patterns. The particular pattern selected will depend in part on many of the factors listed above, in regard to concavity shape and size. Usually, though not always, they are uniformly spaced from each other.

The distance between concavities can also vary to some extent. (The distance herein is expressed as the ratio of center-to-center spacing, divided by the surface diameter of the concavity). In the case of a typical turbine engine assembly, the described ratio will range from about 1.0 to about 3.0. In some instances, a pattern of uniformly spaced concavities may include a staggered alignment of concavities between other rows of concavities. Fluid flow studies like those mentioned above can be used to readily determine the most appropriate pattern of concavities for a given situation. It should also be noted that the pattern itself could be varied along different surface sections of the turbomachine. (Other details regarding the use, shape, and arrangement of concavities on metal surfaces exposed to gas flow are provided in U.S. Pat. No. 6,504,274 (R. Bunker et al), which is incorporated herein by reference).

The concavities can be formed by a variety of methods. Non-limiting examples include machining methods, such as various milling techniques. Other machining processes which are possible include electro-discharge machining (EDM) and electro-chemical machining (ECM). In some cases, the concavities could be formed during casting of the particular component, e.g., the investment-casting of a turbine rotor or shroud. As one example, an investment mold surface could be provided with a selected pattern of positive features, e.g., “mounds”, domes, pyramids, pins, or any other type of protrusions or turbulation. (Some of the methods for providing these features to various surfaces are described in U.S. patent application Ser. No. 10/841,366 (R. Bunker et al), which is incorporated herein by reference). The shape of the positive features would be determined by the desired shape of the concavities, which would be inverse to the positive feature. Thus, after removal of the mold, the part would include the selected pattern of concavities. Those skilled in the art will be able to readily determine the most appropriate technique (or combination of techniques) for forming the concavities on a given surface.

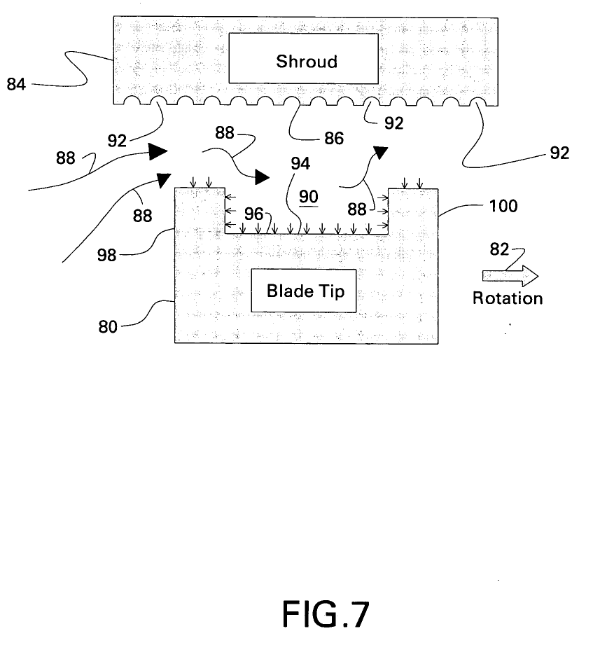

FIG. 7 is a sectional view of a portion of another turbine rotor blade, with an emphasis on blade tip section 80, and shroud 84. The shroud includes lower surface 86. The direction of rotation of the blade in operation is illustrated by arrow 82. The figure also depicts leakage gas 88, moving toward and through interface region/clearance gap 90.

FIG. 7 provides a non-limiting illustration of a pattern of concavities 92, incorporated into shroud surface 86. As mentioned above, the specific location, shape, and size of the concavities will vary to meet the requirements for a particular assembly and turbomachine. The presence of the concavities can greatly restrict the flow of leakage gas 88 through gap 90. As explained previously, a decrease in the amount of leakage gas can considerably improve the efficiency of the turbine. (In the same manner, a suitable pattern of concavities could be incorporated into the shroud depicted in FIG. 3, i.e., within lower surface 48 of shroud 14).

The various embodiments of the present invention are applicable to a variety of rotor blade shapes, and more specifically, to the various shapes for the tip region of the blade. For example, blade tip section 80 has a shape different from that of tip section 20 (FIG. 3). Tip section 80 includes upper tip surface 94. Surface 94 itself includes a recessed tip region 96, along with protruding regions 98 and 100.

The concavities may be incorporated into various surfaces of the assembly depicted in FIG. 7, in lieu of, or in addition to, their presence on shroud surface 86. Other possible locations for the concavities are indicated with the various small arrow symbols. As shown, it is possible to incorporate the concavities into various portions of upper tip surface 94. Similarly, concavities can be incorporated into any portion of tip surface 50 (FIG. 3).

In many instances, it appears that the greatest benefit in terms of fluid flow restriction is obtained by incorporating the concavities primarily into surfaces of the stationary member, as compared to the rotational member. However, different types of assemblies may benefit from placement of these features on the rotational member, whether or not they are present on the stationary member. Those skilled in the art will be able to readily determine the best location(s) for the placement of concavities for a given type of assembly, based on these teachings, as well as the various experimental observations noted above.

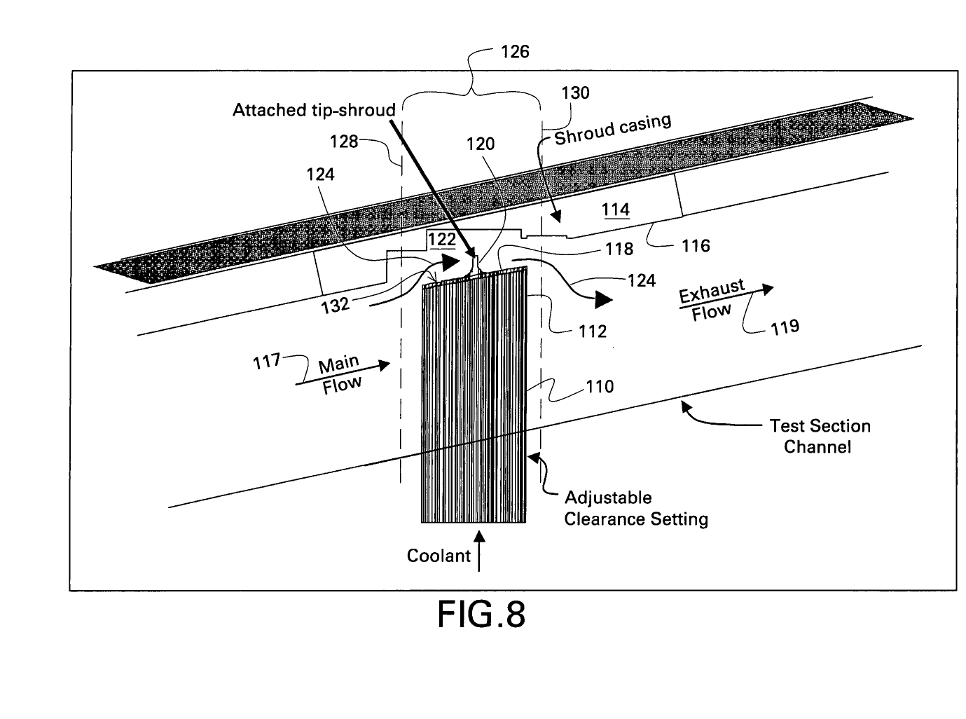

FIG. 8 is a depiction of another type of assembly for embodiments of the present invention. The figure is a sectional view of rotor blade portion 110, which includes tip section 112. The figure also depicts shroud casing 114, which can assume a variety of different shapes and sizes. The shroud casing includes a lower surface 116. The figure also depicts the primary path of hot gas flow 117 and exhaust gas flow 119 within this particular assembly.

Rotor blade portion 110 includes a tip-shroud 118 (not to be confused with “shroud casing” 114), which is attached to tip section 112 by conventional means. The tip shroud can include one or more protrusions or “seal teeth” 120, which can vary considerably in shape and size. The tip shroud and attached seal tooth function in part to reduce the effective size of clearance gap 122. As noted previously, a decrease in the size of the clearance gap can desirably impede the flow of leakage gas 124 (which escapes from hot gas flow 117) through the gap.

As a helpful, non-limiting illustration, an interface region is depicted in FIG. 8. Interface region 126 is shown as a length bounded by dashed lines 128 and 130, and encompasses at least the clearance gap 122. The length of the interface region (i.e., the dimension parallel to flow lines 117 and 119) can vary to some degree, as noted previously. In this instance, it generally represents at least the area of restricted dimension between the facing surfaces of tip shroud 118 and shroud casing 114, but usually extends to a greater extent along the length-dimension. As an example, the length of interface region 126 is depicted as extending about 10% beyond the length of tip shroud 118, in either direction along the length-dimension.

Thus, in the embodiment of FIG. 8, the concavities are usually incorporated into at least a portion of the lower surface 116 of shroud casing 114, within interface region 126. However, they can also be incorporated (or can be alternatively incorporated) into various sections of tip shroud 118, including the generally planar section 132, and/or on any portion of the surface of seal tooth 120. As in other embodiments, the most effective location for the concavities can be determined without undue effort by those skilled in the art, with reference to these teachings.

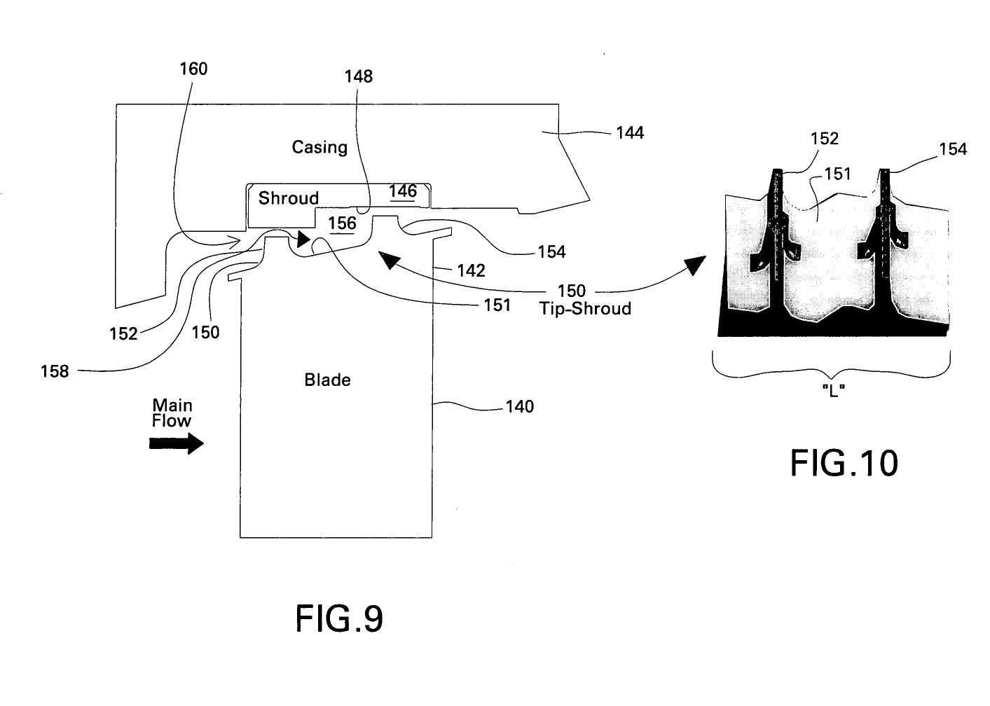

FIG. 9 is yet another depiction of an assembly for certain inventive embodiments. The figure is a sectional view of rotor blade portion 140, which includes tip section 142. Shroud casing 144 is also shown. The shroud casing retains shroud 146, which has a lower face 148. Rotor blade portion 140 includes a tip-shroud 150, attached to tip section 142. In this embodiment, the upper surface 151 of the tip shroud includes two seal teeth 152, 154. The seal teeth are also depicted in FIG. 10, which is a top planar view of tip section 142. As in other embodiments, the tip shroud and attached seal teeth in FIGS. 9 and 10 function in part to reduce the effective size of clearance gap 156. In this manner, the flow of leakage gas 158 through the gap is desirably impeded.

In line with the teachings above, the interface region 160 generally encompasses clearance gap 156, and usually extends farther along the area which faces upper surface 151 of the tip shroud. In other words, the interface region can be said to extend about 10% beyond the length (L) dimension shown in FIG. 10, in both directions. The concavities described above are usually incorporated into at least a portion of the lower face 148 of shroud casing 144, within interface region 160. They can also (or can alternatively) be incorporated into various sections of tip shroud 150, including the generally planar section 151 (FIG. 10), as well as surface sections of seal teeth 152 and 154.

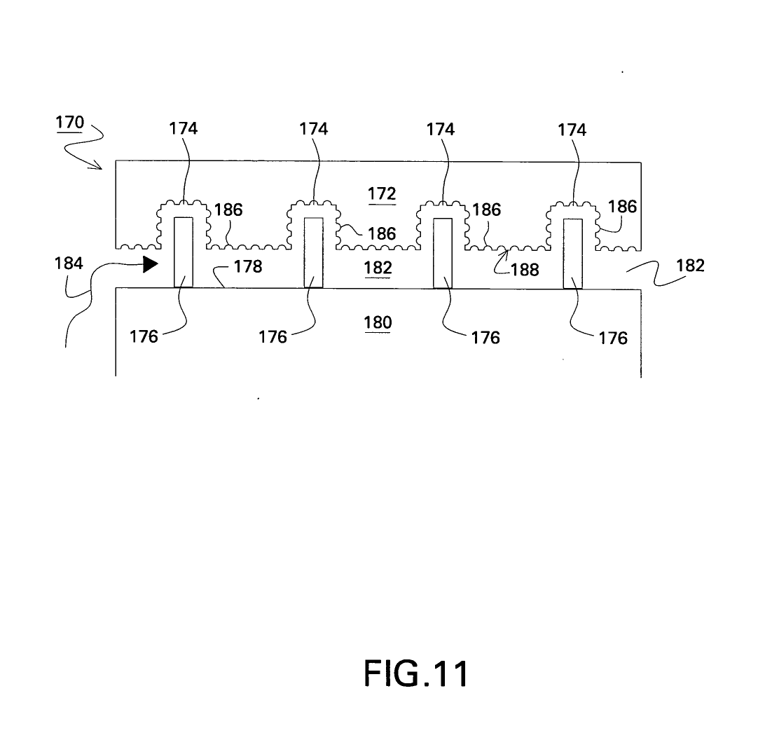

FIG. 11 is an illustration of a labyrinth seal. In general, labyrinth seals also provide a region of restricted fluid flow, e.g., a tortuous path between a stationary surface and a rotating surface. In the present, non-limiting example, the labyrinth seal has been formed within a shroud-blade tip assembly 170. Shroud 172 includes a multitude of recessed regions 174, which function in part as leakage discouragers. The recessed areas are depicted as circumferential grooves disposed within the body of the shroud, but their shape and size can vary considerably.

Another element of the labyrinth seal is the set of tip cap flow discouragers 176 attached to the upper portion of blade tip 180. The tip cap flow discouragers are in alignment with recessed regions 174, so as to define clearance gap 182, and form the labyrinth arrangement. As in the case of structures in the other embodiments, the labyrinth seal impedes the flow of leakage gas 184 through gap 182.

In this embodiment, concavities 186 are shown as being incorporated into the shroud 172. The concavities can be formed on both the surfaces of recessed regions 174, as well as on the lower surface 188 of the shroud. As in the other embodiments, the size, shape, and arrangement of the concavities can vary greatly, depending on many of the factors discussed previously. Moreover, the concavities can also be incorporated (or can be alternatively incorporated) into various sections of tip cap 178. These sections include blade tip surface 178, as well as any of the surfaces of flow discouragers 176.

FIG. 11 depicts a labyrinth seal between a shroud and the tip section of a turbine blade. However, it should be emphasized that many other types of labyrinth seals are amenable to the features of the present invention. For example, labyrinth seals can be found in other sections of turbomachines. Non-limiting examples include: the various high-pressure packing seals between the compressor and turbine sections; stage-to-stage turbine spacer wheel seals; inducer flow seals, stage-to-stage compressor wheel seals; shaft leakage seals; and shaft gland seals. (It should also be understood that the invention is suitable for other types of seals as well, e.g., brush seals, abradable seals, foil seals, and the like).

Assemblies having each of these types of seals are known in the art. As an example, gland seals are typically used with closed circuit cooling systems. They are often incorporated into assemblies within steam turbines, as described in U.S. Pat. No. 5,031,921, incorporated herein by reference. Examples of inducer seals used in gas turbine engines can be found in U.S. Pat. No. 4,466,239, incorporated herein by reference. Moreover, U.S. Pat. No. 5,074,111 (also incorporated herein by reference) describes various types of seals utilized to isolate the compressor and turbine sections of turbine engines. Those skilled in the art will be able to recognize other specific regions within turbomachines which may benefit from the invention described herein.

As alluded to above, the inventive concepts described herein can be applied to different types of fluids. Thus, the term “fluid” is meant to describe a gas, a liquid, a gas-liquid mixture; a two-phase fluid, a multi-component fluid; or various combinations thereof. As a non-limiting example, the invention can be incorporated into a water turbine, e.g., one used in any type of hydroelectric system.

Moreover, It should also be emphasized that many different types of turbomachines can incorporate the features of the present invention. Non-limiting examples of other types of turbomachines include gas compression units, liquid compression units, expanders, hydroturbines, and steam turbines. Combinations of these machines are also within the scope of this invention.

Although this invention has been shown and described with respect to the detailed embodiments thereof, it will be understood by those skilled in the art that various changes in form and detail thereof may be made without departing from the spirit and scope of the invention. Furthermore, all of the patents, patent articles, and other references mentioned above are incorporated herein by reference.

What is claimed:

1. An assembly in a turbomachine, comprising a rotating member having an interface region with a stationary member, wherein the interface region comprises a pattern of concavities.

2. The assembly of claim 1, wherein the concavities are in the shape of a hemisphere or a partial hemisphere.

3. The assembly of claim 2, wherein each concavity has an average depth in the range of about 0.5 mm to about 6 mm.

4. The assembly of claim 1, wherein the pattern comprises an array of uniformly spaced concavities.

5. The assembly of claim 4, wherein the uniformly spaced concavities comprise a staggered alignment between rows of concavities.

6. The assembly of claim 1, wherein the interface region is a flow-restriction region which limits the flow of a fluid between the rotating member and the stationary member.

7. The assembly of claim 6, wherein the fluid comprises a substance selected from the group consisting of a gas, a liquid, a gas-liquid mixture; a two-phase fluid, a multi-component fluid; and combinations of any of the foregoing.

8. The assembly of claim 1, wherein the turbomachine is a gas turbine engine.

9. The assembly of claim 1, wherein the rotating member is a turbine blade or bucket.

10. The assembly of claim 1, wherein the stationary member is a shroud.

11. The assembly of claim 1, wherein at least a portion of the interface region comprises a seal between the rotating member and the stationary member; and the pattern of concavities is disposed on at least one surface of the seal.

12. The assembly of claim 11, wherein the seal is a labyrinth seal; and the pattern of concavities is disposed on at least one surface of the labyrinth seal.

13. The assembly of claim 12, wherein the labyrinth seal comprises a high-pressure packing seal between a section of a compressor and a section of a turbine.

14. The assembly of claim 12, wherein the labyrinth seal comprises a stage-to-stage turbine spacer wheel seal.

15. The assembly of claim 12, wherein the labyrinth seal comprises a stage-to-stage compressor wheel seal.

16. The assembly of claim 12, wherein the labyrinth seal comprises an inducer flow seal.

17. The assembly of claim 12, wherein the labyrinth seal comprises a shaft leakage seal.

18. The assembly of claim 12, wherein the labyrinth seal comprises a gland seal.

19. The assembly of claim 1, wherein the turbomachine is selected from the group consisting of a gas compression unit, a liquid compression unit, an expander, a hydroturbine, a steam turbine, a water turbine, and combinations thereof.

20. A turbomachine which comprises opposing surfaces of a rotating member and a stationary member, wherein a pattern of concavities is disposed on at least one of the opposing surfaces.

21. A method for restricting the flow of a fluid through a gap between a stationary member and a rotating member in a turbomachine, comprising the step of forming a pattern of concavities on at least one surface of the stationary member or the rotating member, wherein the concavities have a size and shape sufficient to impede fluid flow.

22. The method of claim 21, wherein the concavities are formed by a machining technique.

23. The method of claim 21, wherein the concavities are formed during a casting process used to manufacture the stator or the rotor.

24. The method of claim 23, wherein the casting process comprises investment casting.

25. The method of claim 21, wherein the fluid comprises a substance selected from the group consisting of a gas, a liquid, a gas-liquid mixture; a two-phase fluid, a multi-component fluid; and combinations of any of the foregoing.
